(19) United States
(12) Patent Application Publication
(10) Pub. No.: US 2005/0157898 A1
(43) Pub. Date: Jul. 21, 2005

(54) Housing for a hearing device

(76) Inventor: Bruno Gabathuler, Stafa (CH)

Correspondence Address: PEARNE & GORDON LLP, 1801 EAST 9TH STREET, SUITE 1200, CLEVELAND, OH, 44114-3108, US

(21) Appl. No.: 10/759,631

(22) Filed: Jan. 16, 2004

(51) Int. Cl. H04R 25/00

(52) U.S. Cl. 381/322; 381/324; 381/323

(57) ABSTRACT

The housing for hearing aids or hearing devices, with a housing shell, a base plate connected to the housing shell and at least a cap arranged at the housing shell or the base plate, consists of at least one electronic or electromechanical element arranged within the cap.

### BACKGROUND OF THE INVENTION

This invention relates to the housing for hearing aids or hearing devices, with a housing shell, a base plate connected to the housing shell and at least a cap arranged at the housing shell or the base plate.

Functional elements, such as on-off switches, rotary switches or coils for wireless transmission, to be manipulated from the outside are arranged on the shell of commonly known hearing devices.

The arrangement of one or more such elements may cause problems as there may not be enough space for it, which causes an enlargement of the size of such shells.

This may cause undesirable enlargement of the size of the housing or unfavorable spacing proportions especially of in-the-ear hearing devices, which usually do not have any freedom of design due to the predetermined shape of the ear canal and the need of ultimate miniaturization. These disadvantages appear as well for behind-the-ear hearing devices.

### SUMMARY OF THE INVENTION

It is an object of the present invention to find a hearing device housing eliminating or at least limiting those disadvantages.

The present invention provide a housing for hearing aids or hearing devices, with a housing shell, a base plate connected to the housing shell and at least a cap arranged at the housing shell or the base plate, whereby at least one electronic or electromechanical element is arranged within the cap. The amount of space will thereby optimally be used by the utilization of the surface of the cap, which usually is accessible from the outside. This applies especially for in-the-ear hearing devices, whereby the area accessible from the outside during operation is practically limited to the cross section of the ear channel, which is filled to the bigger part by the cap.

In one embodiment of the invention the electronic or electromechanical elements are having an actuator, whereby the actuator of the element is operable from the outside of the housing shell or the base plate respectively in the closed state of the cap. The actuator may for instance be a push-button to set up functions of the hearing device or the hearing aid by the user.

In another embodiment of the invention the electronic or electromechanical elements consist of switches, coils or memory circuits. It is clear that even other elements such as potentiometers for the continuously adjustable adjustment of electrical signals may be used.

In another embodiment of the invention, the cap consists of contact elements, said contact elements are electrically connected or arranged respectively with corresponding contact elements of the base plate or housing respectively. Thus providing advantageously a simple and reliable connection between the electronic or electromechanical elements arranged within the cap and the base plate. A simple exchange of elements or of the whole cap respectively will thereby be possible, without the need of loosening any hard-wired connections.

In a further embodiment of the invention the contact elements are built as contact tongues or contact strips made out of conducting metal, preferably consisting of or made out of precious metal. That provides an optimal electrically conductive connection with a high degree of corrosion resistance.

In a further embodiment of the invention the cap is built as a battery support. The cap therefore consists of elements for the fastening or supporting of a battery as power source for the hearing aid or hearing device respectively. The battery will therefore be fixed in the inside of the housing in the closed position of the cap and may easy be replaced or removed in the opened position of the cap.

In a further embodiment of the invention spring contact elements or contact tongues are arranged on the base plate or the housing shell, which are in electrical contact with corresponding contact elements of the cap in its closed state. The electronic or electromechanical elements of the cap may thus be unlockable connected directly with the electronic components of the base plate.

In a further embodiment of the invention the cap is pivotable connected by an axis to the housing shell or the base plate respectively. The axis may be hold directly within the base plate or the housing shell. The axis will preferably be arranged unlockable, thus allowing a replacement of the cap if required.

By the implementation of the housing according the present invention the space within the housing will be optimally used to provide the necessary or useful number of actuating elements, whereby those actuating elements may be easily replaced or exchanged on demand. New functions may thus be subsequently added on demand, new elements may be supplied or defective elements may be exchanged without the need of shutting down the hearing aid or the hearing device for a longer amount of time.

### DESCRIPTION OF THE DRAWINGS

For purpose of facilitating and understanding of the invention, there is illustrated in the accompanying drawings preferred embodiments thereof to be considered in connection with the following description. Thus the invention may be readily understood and appreciated.

FIG. 1 is a view of an in-the-ear hearing aid with opened battery cap;

FIG. 2 is a view of a cap according the present invention;

FIG. 3 is a further view of the cap according FIG. 2 attached to the base plate of the hearing aid according FIG. 1.

### DESCRIPTION OF A PREFFERED EMBODIMENT

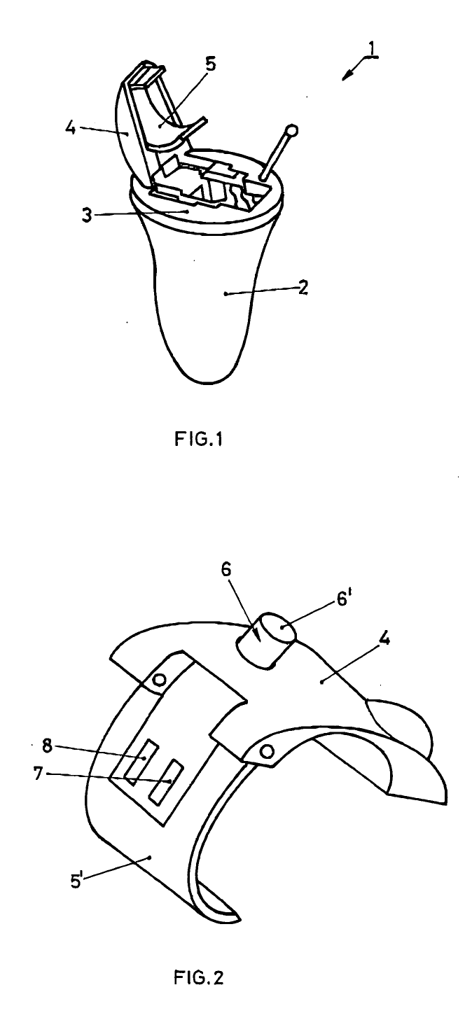

FIG. 1 is showing the view of an in-the-ear hearing aid 1 with a housing shell 2 adapted to the human inner ear and a base plate 3, in this figure visible from the outside. A cap 4 is pivotable arranged at the base plate 3 and shown in its opened position.

The cap 4 consists of a clamp 5 for holding a battery (not shown in FIG. 1), which battery supplies the hearing aid 1 with electrical energy.

The cap 4 is shown in FIG. 2 in its dismantled state. A push button 6 is arranged within the cap 4. The head 6′ of the push button 6 projects beyond the outer surface of the cap 4 and is therefore manually operable. Furthermore, electrical contact strips 7 and 8 are arranged on the clamping wings 5′ to be swiveled into the inside of the base plate 3. These contact strips 7 and 8 are electrical connected with the push button 6 of the cap 4.

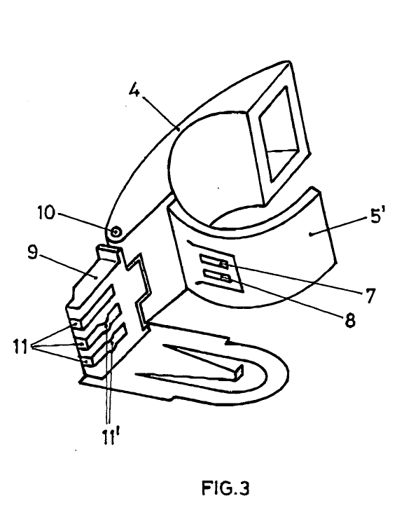

FIG. 3 shows the cap 4 connected over a pin 10 with the hinge element 9 of the base plate 4 in its open state, whereby the base plate 3 and the housing shell 2 are not shown for better overview purpose. The hinge element 9 on his part features electrical contact tongues 11. These contact tongues 11 consist advantageously of cams 11′ protruding elastically ahead to realize a reliable electrical contact with the contact strips 7 or 8 respectively in the closed state of the cap 4.

The contact tongues 11 are connected over conductors or circuit paths to the electronic components of the hearing aid or hearing device 1 respectively. These components usually are arranged directly to the hinge element 9 or the base plate 3.

Electrical components 6 such as push buttons or rotary switches, which have to be accessible from the outside, or coils, which have to be arranged at the outside, are thus advantageously space saving arranged. The electrical connection to the electronic components arranged within the hearing aid 1 is ensured over the contact strips 7 and 8 or the contact tongue 11 respectively. The cap 4 together with the correspondent component 6 may be easy removed, for instance if one of the components is defective or for the upgrading of the hearing aid 1 with additional or new components 6.

1. A housing for hearing aids or hearing devices, with a housing shell, a base plate connected to the housing shell and at least a cap arranged at the housing shell or the base plate, whereby at least one electronic or electromechanical element is arranged within the cap.

2. The housing according to claim 1, whereby the electronic or electromechanical elements are having an actuator, whereby the actuator of the element is operable from the outside of the housing shell or the base plate respectively in the closed state of the cap.

3. The housing according to claim 1, whereby the electronic or electromechanical elements consists of switches, coils or memory circuits.

4. The housing according to claim 1, whereby the cap consists of contact elements, which contact elements are electrically connected or arranged respectively with corresponding contact elements of the base plate or housing respectively.

5. The housing according to claim 4, whereby the contact elements are built as contact tongues or contact strip made out of conducting metal, preferably consisting of or made out of precious metal.

6. The housing according to claim 1, whereby the cap is built as a battery support.

7. The housing according to claim 1, whereby spring contact elements or contact tongues are arranged on the base plate or the housing shell, which are in electrical contact with corresponding contact elements of the cap in its closed state.

8. The housing according to claim 1, whereby the cap is pivotable connected by an axis to the housing shell or the base plate respectively.
